(19) United States
(12) Patent Application Publication
(10) Pub. No.: US 2003/0051429 A1
(43) Pub. Date: Mar. 20, 2003

(54) Roof safety system

(76) Inventor: Fred E, Hovenier, Yorba Linda, CA (US)

Correspondence Address: KIT M. STETINA, STETINA BRUNDA GARRED & BRUCKER, SUITE 250, 75 ENTERPRISE, ALISO VIEJO, CA, 92656, US

(21) Appl. No.: 09/957,374

(22) Filed: Sep. 20, 2001

(51) Int. Cl. E06C 7/18; A62B 35/00; A62B 1/16

(52) U.S. Cl. 52/651.1; 52/651.02; 52/39; 182/9; 182/112; 182/10; 182/11

(57) ABSTRACT

There is provided a roof safety system for facilitating a unencumbered lateral movement of a user's safety tether line along a length of a roof truss. The system comprises first and second elongated anchor members that are respectively positioned at first and second locations along the length of the roof truss. Moreover, a tension line is engaged to the first and second elongated members to extend therebetween and is further slidably connectable by the user's safety tether line. By doing so, the tension line facilitates the unencumbered lateral movement of the user's safety tether line between the first and second positions along the length of the roof truss.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to a roof safety system, and more particularly to an improved roof safety system that facilitates continuous unencumbered lateral movement of a user's safety tether line along a length of a roof line while prohibiting the user from falling from the roof.

The use of roof safety systems for roof construction and/or repairs to prevent accidental falls is well known. Roof construction, repair, and other maintenance-related operations require construction workers to be exposed to dangerous heights and on steeply pitched roof working surfaces. As such, the possibility of lost footing and decreased stability is substantial which leads to numerous accidental falls. Accidental falls can cause great bodily injuries, and oftentimes lead to death.

In an attempt to prevent such detrimental consequences, various safeguards have been enacted in the prior art. One form of safeguard is to enforce minimum safety guidelines among the construction workers. Minimum safety guidelines may promote a safer workplace, thus decreasing the propensity of accidental falls. However, such a safeguard is only a preventive remedy, and cannot eliminate the actual falls from occurring.

In hopes of achieving the greatest safety possible, many construction employers and/or governmental agencies such as the Occupational Safety and Health Administration (OSHA) have recently begun mandating the use of roof safety devices in an attempt to increase worker safety.

In order to conform to OSHA's safety regulations, roof safety devices have been recently introduced in construction, especially in roof construction. A typical prior art roof safety device generally comprises a safety tether line, a harness, and a releasable hook mechanism which may be attached to a stationary anchor mounted upon the roof. One end of the safety tether line is attached to the releasable hook mechanism, whereas its other end is attached to the harness disposed about a user's (e.g., a construction worker's) body. The safety tether line is pre-measured such that its length is less than the distance of the roof or the distance to the ground. The releasable hook mechanism may be selectively attached to the stationary anchor so as to protect the user against hitting the ground should an accidental fall occur.

However, such prior art roof safety devices have substantial limitations which detract from the widespread use. Foremost of such limitations is that they often mitigate work efficiency and timing. More specifically, although the roof safety device gives its user the freedom to move upwardly and downwardly along the roof, such device restricts lateral movement along an arcuate length of the safety tether line extending between the harness and the fixed, stationary anchor. Thus, the user of such device have to repetitively relocate the releasable hooking mechanism to different stationary anchors in order to laterally move about the length of the roof truss.

By having such characteristic, the prior art roof safety device not only compromises the user-convenience, but may further defeat the purpose of even utilizing such device, i.e., to ensure the safety of its user at all times. In this regard, when the releasable hooking mechanism is relocated from one anchor to another anchor, the user is left without any form of protection against accidental falls. Therefore, the roof safety device may leave its user vulnerable to great bodily injuries, or even death.

In addition, the use of multiple permanent anchors mounted at differing lateral locations along the roof structure requires substantial labor time to mount and eventually remove the same from the roof structure, thereby increasing construction costs.

Thus, there exists a substantial need in the industry, and in the roof construction business in particular, for a roof safety system that would allow its user to freely move along the length of a roof while protecting the user from injury due to accidental falls. Further, there exists a need for a roof safety system that is user-friendly, while mitigating expenditures of time and energy when being utilized.

### SUMMARY OF THE INVENTION

The present invention specifically addresses and overcomes the above described deficiencies of prior art roof safety devices by providing a continuous tension line positioned vertically above the roof surface that extends between two maximum separated locations along a length of a roof. By doing so, the user's safety tether line attached thereto via a releasable hooking mechanism, for example, is free to laterally move unencumbered along the entire length of the roof truss, thereby facilitating both up and down and lateral movement upon the roof. Moreover, the roof safety system of the present invention mitigates expenditures of time and energy by simplifying installation and removal of the safety device from the roof structure. In this respect, not only does the present invention significantly reduce the risk of danger at all times, but also increases user comfort when being utilized.

In accordance with a preferred embodiment of the present invention, there is provided a roof safety system for facilitating a continuous movement of a user's safety tether line throughout the length of a roof structure. The system comprises first and second elongated anchor members that are respectively positioned at first and second laterally spaced locations along the roof structure. A tension line extends between the first and second anchor members and is sized to slidably receive the user's safety tether line. By doing so, the tension line facilitates the continuous unencumbered lateral movement of the user's safety line along the length of the tension line.

In accordance with a preferred embodiment of the present invention, the first and second anchor members each comprise a female portion and a male portion adapted to be axially inserted therein and extend vertically upward therefrom. Each female portion is formed to be securely and rapidly attached to a roof truss, rafter and/or joist and includes an aperture at its upper end to receive the respective male portions therein. The length of the aperture is sized to position the upper end of the male portion at a vertical elevation above the roof while the female portion is located at a vertical location below the roof.

Each male portion of the anchor members has an upper distal end with an eyelet adjacent thereto. Each eyelet is formed to engage the tension line therethrough to facilitate securing the tension line between the first and second anchor members.

In operation, the female portion of each anchor member may be rapidly and securely attached to roof truss structures disposed on opposite ends of the roof line, with the upper portion of each female anchor being disposed vertically below the intended roof line. Subsequently, the male portion of each of the anchor members may be axially inserted into the upper aperture of each female anchor member such that the uppermost end of each of the male anchor members extends approximately one to three feet above the roof structure. The tension line may then be extended between the anchor members and through the eyelets formed on each member. Subsequently, suitable tensioning members and/or fasteners may be applied to the tension line, and the tension line may be manually tensioned and secured in a tensioned condition between the anchor members. Disposed in such a manner vertically above the roof line, users may rapidly attach their safety tether lines to the tension line and freely move laterally, as well as upwardly and downwardly, along the roof's surface while being attached via the safety line to the tension line such that, even upon encountering an accidental fall, the safety line will maintain the worker upon the roof's surface and avoid the worker from falling off the roof structure.

In the preferred embodiment, when the roof structure is substantially completed, the male portions of the anchor structure may be rapidly and axially removed from the roof structure while leaving the female portion of the anchor members below roof line. Subsequently, the remaining portion of the roof above the female portion of the anchor member may be concealed and covered with roofing material. As such, disassembly of the structure of the present invention is facilitated in a rapid and cost-efficient manner with the female portion of each anchor member being sacrificial, i.e., being left beneath the roof structure. Of course, the male portions and tension line may be reused on additional roof structures.

### BRIEF DESCRIPTION OF THE DRAWINGS

These as well as other features of the present invention will become more apparent upon reference to the drawings wherein:

FIG. 1 is a perspective view of a roof safety system constructed in accordance with a preferred embodiment of the present invention, illustrating the first and second elongated anchor members having a tension line therebetween extending above a roof structure;

FIG. 2 is a perspective view of one of elongated anchor members shown in FIG. 1, illustrating its female portion and a complimentary male portion construction;

FIG. 3 is a perspective view of a preferred mounting of an elongate anchor member to a strengthened roof truss;

FIG. 4 is a perspective view of a manner in which a female portion is attached to a rafter; and

FIG. 5 is a side view of a manner in which an elongate anchor member is attached to an I-joist; and

FIG. 6 is a perspective view of the male portion shown in FIGS. 2, 3, or 5, illustrating its removal from the respective female portion when the roof structure is substantially completed.

### DETAILED DESCRIPTION OF THE INVENTION

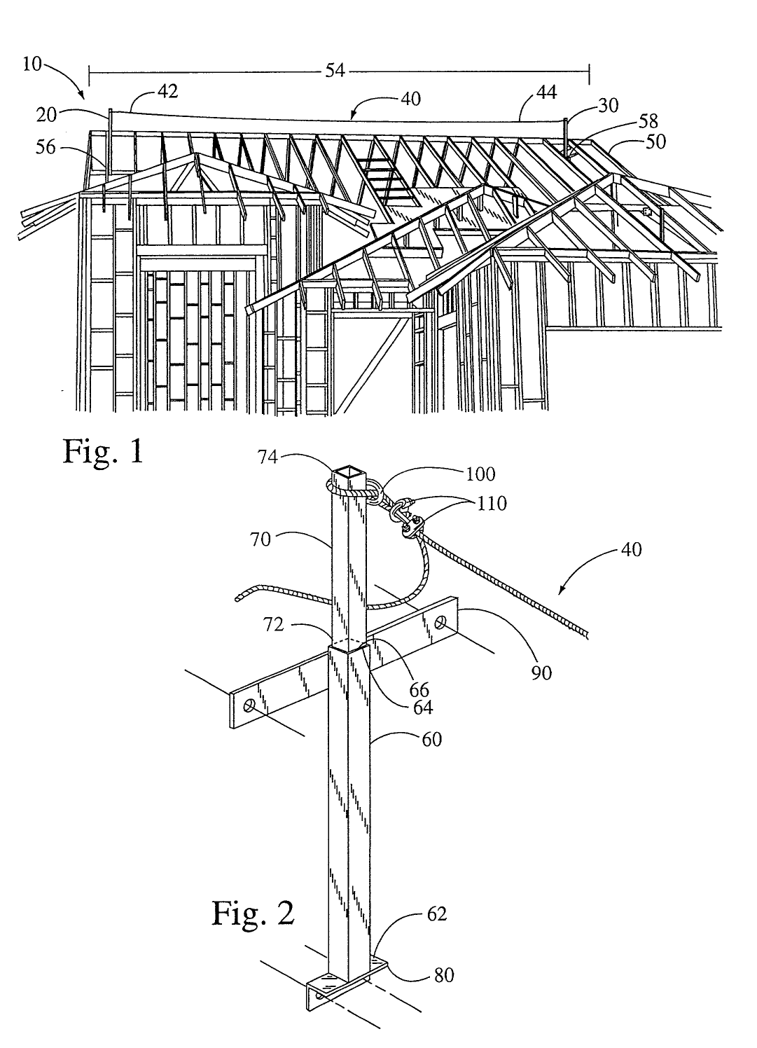

Referring now to the drawings wherein the showings are for purposes of illustrating preferred embodiments of the present invention only, and not for purposes of limiting the same, FIG. 1 perspectively illustrates a roof safety system 10 constructed in accordance with a preferred embodiment of the present invention. The roof safety system 10 comprises a first elongated anchor member 20 and a second elongated anchor member 30 with a tension line 40 extending therebetween. As will be recognized, a conventional safety tether line and harness worn by a construction worker (not shown) may be attached to the tension line 40. The length of the safety line is sized to be less than the depth of the roof structure such that in the event of an accidental fall, the safety line will tether the worker upon the roof and prevent the worker from falling to the ground.

As will become apparent, in addition to ensuring the safety of its user, the roof safety system 10 simultaneously facilitates a continuous movement of a user along the depth and lateral length 54 of the roof structure 50.

Referring more particularly to FIG. 2, the first and second elongate anchor members 20 and 30 are preferably formed having identical structures. However, one of ordinary skill in the art may contemplate such members 20, 30 to be structurally different. In this regard, one of ordinary skill in the art will obviously foresee a use of more than two members 20, 30 to strategically move around the roof truss 50. It is preferred for the sake of practicality that two elongated anchor members 20, 30 are used to achieve the purpose of the present invention.

The first and second elongated anchor members 20, 30 may be fabricated from any suitable material such as metal, composite, or polymer. Furthermore, although the first and second elongated members 20, 30 may be formed to have a variety of shapes, configurations, and geometries, it is preferred that the elongated members 20, 30 are formed having a generally square tubular configuration.

The first elongated and second elongated anchor members 20, 30 each comprise a female portion 60 and a male portion 70 which are complimentary to each other. In particular, each female portion 60 has a lower female end 62 and an upper female end 64. Similarly, each male portion 70 of the first and second elongated anchor members 20, 30 also has a lower male end 72 and an upper male end 74. The lower male ends 72 are adapted to be axially insertable into the upper female ends 64 and extend vertically therefrom. More specifically, there is provided an aperture 66 at each of the upper female ends for slidably receiving the lower male end 72 therein.

In addition, each of the upper male ends 74 has an eyelet 100 formed adjacent thereto. Each eyelet 100 is formed to engage the tension line 40 therethrough to facilitate securing the tension line between the first and second elongated anchor members 20, 30, as will be better described below.

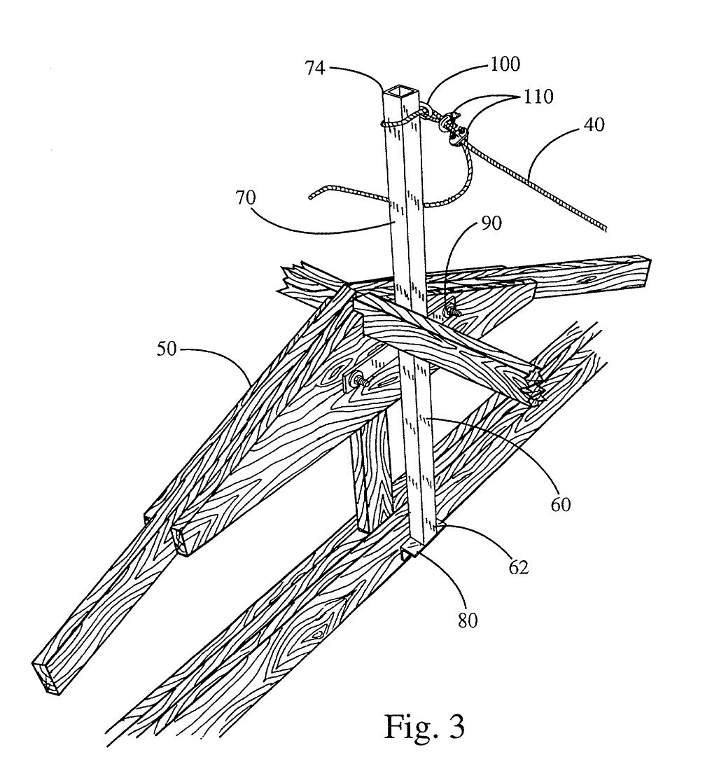

Referring now to FIGS. 1 and 3, the first and second elongated anchor members 20, 30 are positioned between two maximum separated locations along a length of a roof, which will be respectively referred to as first and second locations 56, 58. In particular, the female portion 60 of each anchor member 20, 30 is securely attached to roof truss structures disposed on opposite ends of the roof line, namely, first and second locations 56, 58. When such attachment is made, it is recommended that the upper female end 64 is disposed vertically below the intended roof line. Moreover, the lower female ends 62 of the anchor members 20, 30 are each attached to the respective first and second locations 56, 58. One of ordinary skill in the art will realize that there are a number of ways to accomplish such attachment. However, one manner of attaching the lower female ends 62 to the respective first and second locations 56, 58 is via mounting post brackets 80.

The mounting post brackets 80 is engaged to the lower female ends 62 by being fastened, welded, or adhesively applied, thereto. Simply put, the mounting post brackets 80 can be retrofitted to the lower female ends 62. In the alternative, however, the mounting post brackets 80 may be formed as part of the first female ends 62 when the first female ends 62 are manufactured. Thus, the mounting post brackets 80 are fastened (via screws, rivets, etc.) to the respective first and second locations 56, 58 of the roof truss 50. Additionally, lumbers (e.g., 2×4s) can be positioned adjacent to the sides of the mounting post brackets 80 for reinforcement purposes so as to strengthen the attachment to the respective locations 56, 58.

Each of the female portions 60 may further comprise a horizontally positioned elongated support plate 90 adjacent to its upper female end 64 for the purpose of strengthening the attachment to the respective locations 56, 58. Similar to the mounting post brackets 80, the elongated support plate 90 may be retrofitted, or alternatively, formed to each upper female end 64. The elongated support plate 90 may be attached to the roof truss 50 (via screws or rivets, for example), namely, the part of the roof truss 50 close to the respective locations 56, 58, to increase attachment of the respective female portions 60 thereto.

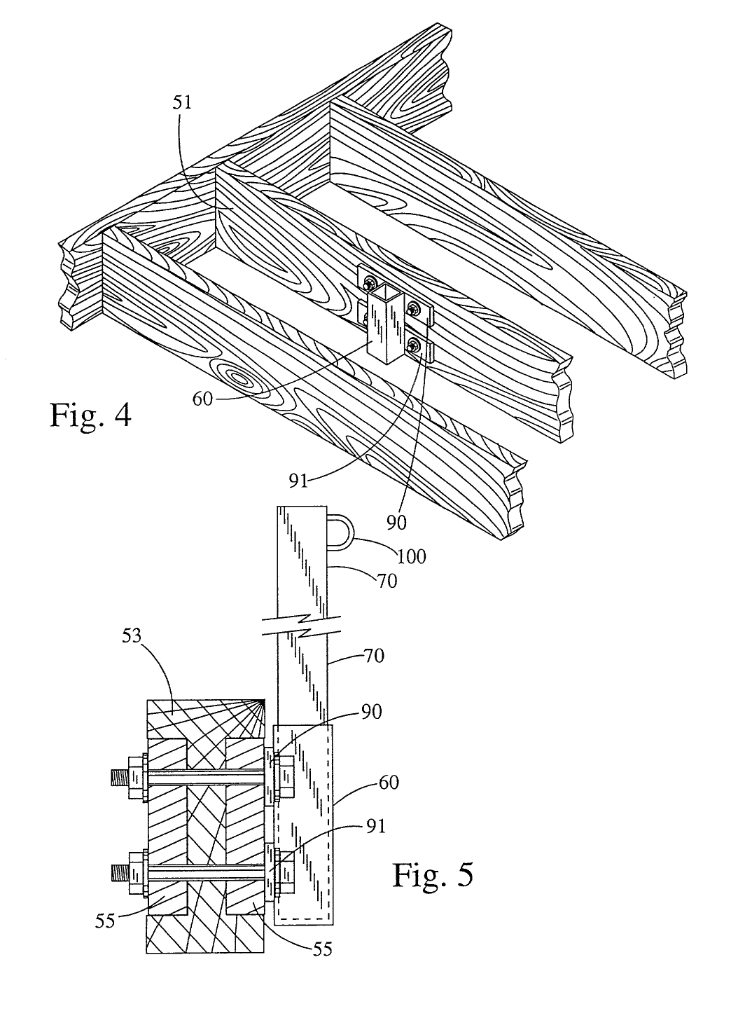

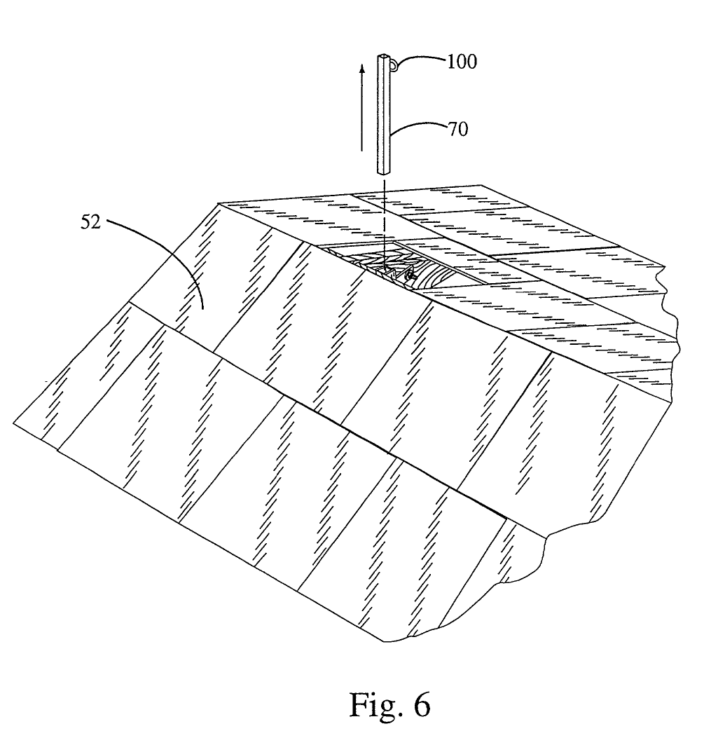

Referring briefly to FIGS. 4 and 5, the first and second elongated members 20, 30 may also be used on a variety of other elevated preformed structures. For instance, the elongated members 20, 30 can engage upon conventional 2×wooden beams, enlarged rafters 51, joists 53 (e.g., I-joists), and the like that make up the essential components in forming the flat floor systems or flat/sloped roof systems. As such, in addition to the above-noted support plate 90, another similar support plate 91 can be formed/retrofitted adjacent to the lower female ends 62. In this regard, both of the support plates 90, 91 may engage through the conventional 2×4 wooden beams, enlarged rafters 51, joists 53, and the like to be fastened in place thereafter (via screws or rivets, for example) in the manner portrayed in FIGS. 4 and 5. As apparent in FIG. 5, when the support plates 90, 91 are attached to joists 53 such as I-joists, plywood fillers 55 can be situated therebetween in order to facilitate their engagement to each other.

Referring now to FIGS. 2 and 3, and after the female portions are secured to the respective locations 56, 58 of the roof truss 50 for example, the lower male ends 72 of each male portion 70 may be axially inserted into the respective apertures 66 formed at the upper female ends 64. The lower male ends 72 are compatible to the respective apertures 66 of the second female ends 64 so as to be slidably engageable therethrough and further vertically extend therefrom. When axially inserted into the respective apertures 66 formed at the upper female ends 64, the upper male ends 74 extend approximately one to three feet above the roof truss 50. The tension line 40 may then be extended between the anchor members 20, 30 (best shown in FIG. 1) and through the eyelets 100 formed adjacent to each upper male end 74. More specifically, a first line end-portion 42 and a second line end-portion 44 of the tension line 40 may respectively circumscribe the separately positioned anchor members 20, 30 at their respective upper male ends 74 and penetrate through the each eyelets 110 thereafter. Subsequently, suitable tensioning members and/or fasteners 110 may be applied to manually tension and secure the tension line 40 between the anchor members 20, 30 in a tensioned condition. By doing so, the tension line 40 forms a generally parallel relationship with the length 54 of the roof truss 50.

As will be recognized, the roof safety system of the present invention is usable with a conventional roof safety device (not shown) worn by the user. As stated above, a typical safety device generally comprises a safety tether line, a harness, and a releasable hook mechanism. More specifically, one end of the safety tether line attaches the releasable hook mechanism, whereas its other end attaches the harness disposed about the user's body. The safety tether line that is connected to the user's body may slidably and removably connect to the tension line 40 via the releasable hooking mechanism. The user may simply latch the releasable hook mechanism on the tension line 40. Due to the relationship formed with the tension line 40, the releasable hook mechanism may then freely slide along the tension line 40 in a continuous unencumbered lateral motion corresponding to the user's movement. By being able to move along the length 54 of the roof truss 50 while being engaged to the tension line 40, the user may safely move between the maximum separated first and second locations 56, 58. As such, the length of the user's safety line allows the user to reach the entirety of the roof structure, including its width and depth, while permitting lateral movement of the user along its length. Simply put, the present invention facilitates the continuous movement of the user between the first and second locations 56, 58 along the length 54 of the roof truss 50, while simultaneously protecting the user should any accidental falls occur.

Moreover, as shown in FIG. 6, the male portions 70 of the anchor members 20, 30 may be rapidly and axially removed from the roof truss structure while leaving the female portion 60 below the roof line. More specifically, when the roof structure is nearly completed, the male portions 70 are slidably and axially removable from the apertures 66 of the respective upper female ends 64. Subsequently, the female portion 60 of each anchor member 20, 30 may be sacrificial, i.e., left beneath the roof structure. By doing so, the roof 52 may be completed without having to remove the female portions 60 from the respective locations 56, 58. As such, there is no extensive need for removable of the roof safety system 10 when the roof 52 is near completion. For example, the need to unfasten, or unweld, the female portions 60 from the roof truss 50 is eliminated. Simply put, the female portions 60 can permanently remain as part of the roof 52, whereas the male portions 70 can simply slide out of their respective female portions 60 to mitigate removable process of the system 10. Moreover, the male portions 70 and tension line 40 may be reused on additional roof structures.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A roof safety system for facilitating a unencumbered lateral movement of a user's safety tether line along a length of a roof truss, the system comprising:
a first elongated anchor member positioned at a first location along the length of the roof truss;
a second elongated anchor member positioned at a second location along the length of the roof truss; and
a continuous tension line engaged to the first and second elongated members to extend therebetween, the tension line being slidably connectable by the user's safety tether line to facilitate the unencumbered lateral movement thereof between the first and second locations along the length of the roof truss.

2. The system of claim 1 wherein the first and second elongated anchor members are each fabricated from a metallic material.

3. The system of claim 1 wherein the first and second elongated anchor members are upwardly vertical from the respective first and second locations to extend above the roof truss and forming a generally perpendicular relationship with the length of the roof truss.

4. The system of claim 1 wherein the first and second elongated anchor members each comprise a female portion and a male portion complimentary thereto.

5. The system of claim 4 wherein each female portion has a lower female end, the lower female ends each being attachable to the respective locations of the roof truss.

6. The system of claim 5 wherein the lower female ends each comprise a mounting post bracket for attachment to the respective locations of the roof truss.

7. The system of claim 5 wherein each female portion has an upper female end, the upper female ends each forming an aperture to receive the respective male portions therein.

8. The system of claim 7 wherein an elongated support plate is formed adjacent to each of the upper female ends for attachment to the roof truss.

9. The system of claim 7 wherein each male portion has a lower male end, the lower male ends each being removably engageable through the aperture of the respective upper female ends so as to be removed therefrom when the roof truss substantially transitions into a roof.

10. The system of claim 7 wherein each male portion has a lower male end, the lower male ends each being axially insertable through the aperture of the respective upper female ends.

11. The system of claim 7 wherein each male portion has an upper male end with an eyelet formed adjacent thereto, the eyelets each engaging the tension line therethrough to facilitate in securing the tension line thereby.

12. The system of claim 1 wherein the tension line has first and second line end-portions each having a tensioning member, the first and second line end-portions being respectively engageable to the first and second elongated anchor members to be each fastened thereafter via the respective tensioning members so as to rigidly extend the tension line between the first and second elongated anchor members.

13. The system of claim 1 wherein the tension line forms a generally parallel relationship with the length of the roof truss.

14. A method of utilizing a roof safety system to facilitate a unencumbered lateral movement of a user's safety tether line along a length of a roof truss, the method comprising the steps of:
a) positioning a first elongated anchor member at a first location along the length of the roof truss;
b) positioning a second elongated anchor member at a second location along the length of the roof truss;
c) extending a tension line between the first and second elongated anchor members; and
d) respectively engaging first and second line end-portions of the tension line to the first and second elongated anchor members, the tension line being slidably connectable by the user's safety tether line to facilitate the unencumbered lateral movement thereof between the first and second locations along the length of the roof truss.

15. The method of claim 14 wherein the first and second elongated anchor members are each fabricated from a metallic material.

16. The method of claim 14 wherein steps a) and b) comprise:
1) upwardly mounting the first and second elongated anchor members from the respective first and second locations to extend above the roof truss and forming a generally perpendicular relationship with the length of the roof truss.

17. The method of claim 14 wherein steps a) and b) comprise:
1) defining a female portion and a male portion complimentary thereto of each of the first and second elongated anchor members, the female portions each having a lower female end with a mounting post bracket and an upper female end with an aperture;
2) attaching the mounting post bracket of each of the lower female ends to the respective locations of the roof truss; and
3) receiving the respective male portions with the aperture of each of the upper female ends.

18. The method of claim 17 wherein step 2) comprises:
i) attaching an elongated support plate formed adjacent to each of the upper female ends to the roof truss.

19. The method of claim 17 wherein step 3) comprises:
i) defining a lower male end and an upper male end with an eyelet of each of the male portions;
ii) removably sliding the lower male ends through the aperture of the respective upper female ends so as to be removable therefrom when the roof truss substantially transitions into a roof; and
iii) engaging the tension line through the eyelet of each of the upper male ends to facilitate in securing the tension line thereby.

20. The method of claim 14 wherein step d) comprises:
1) defining a tensioning member of each of the first and second line end-portions;
2) fastening the first and second line end-portions via the respective tensioning members so as to rigidly extend the tension line between the first and second elongated anchor members; and
3) forming a generally parallel relationship between the tension line and the length of the roof truss.

21. A safety system for facilitating a unencumbered lateral movement of a user's safety tether line along a length of an elevated structure, the system comprising:
a plurality of elongated anchor members positioned at separated locations along the length of the elevated structure; and
a continuous tension line engaged to the elongated anchor members to extend therebetween, the tension line being slidably connectable by the user's safety tether line to facilitate the unencumbered lateral movement thereof between the separated locations along the length of the elevated structure.

22. The system of claim 21 wherein the elongated anchor members each comprise a female portion and a male portion complimentary thereto.

23. The system of claim 22 wherein each female portion has lower and upper female ends, the female portions each being attachable to the respective locations along the length of the elevated structure via elongated support plates formed adjacent the lower and upper female ends thereof.

24. The system of claim 23 wherein the elongated support plates of each of the female portions are attached to a rafter.

25. The system of claim 23 wherein the elongated support plates of each of the female portions are attached to a joist.

26. The system of claim 25 wherein the joist is an I-joist.

27. The system of claim 22 wherein each male portion has an upper male end with an eyelet formed adjacent thereto, the eyelets each engaging the tension line therethrough to facilitate in securing the tension line thereby.

28. The system of claim 23 wherein each male portion has a lower male end and each upper female end forms an aperture, the lower male ends each being removably and axially insertable through the aperture of the respective upper female ends.
